(19) United States
(12) Patent Application Publication
(10) Pub. No.: US 2011/0175781 A1
(43) Pub. Date: Jul. 21, 2011

(54) MULTIPLE BAND ANTENNAS OPERATING WITH A SINGLE STABILIZED PLATFORM

(76) Inventor: JONGSOO KIM, Ft. Lauderdale, FL (US)

(21) Appl. No.: 12/954,775

(22) Filed: Nov. 26, 2010

Related U.S. Application Data
(60) Provisional application No. 61/264,756, filed on Nov. 27, 2009.

(51) Int. Cl. H01Q 3/22; H01Q 3/02

(52) U.S. Cl. 343/766; 343/757

(57) ABSTRACT

An antenna system includes: a single steering platform automatically pointing the antenna system at a specified target; a first antenna coupled to the single steering platform and operable in a first band; a second antenna operable in a second band that is coupled with the first antenna; a controller operably coupled with the single steering platform for switching between the first band and the second band such that the first antenna operates when the first band is available and the second antenna operates when the second band is available.

### CROSS-REFERENCE TO RELATED APPLICATIONS

This application is a non-provisional of, and claims priority from, provisional patent application Ser. No. 61/264,756, filed on Nov. 27, 2009, which is incorporated by reference herein in its entirety.

### STATEMENT REGARDING FEDERALLY SPONSORED-RESEARCH OR DEVELOPMENT

None.

### FIELD OF THE INVENTION

This invention relates to antenna systems, and particularly to antenna systems that operate in two bands such as the Ku-band and L-band.

### BACKGROUND OF THE INVENTION

Stabilized antennas are able to track geo-stationary satellites and maintain their position with respect to the target satellite, even when the stabilized antenna is mounted onto a moving vehicle, such as a ship. Regardless of the ship's movement, once the stabilized antenna is “locked on” to the target, stabilizing systems, such as servo systems, keep the antenna pointing to the target. Stabilized antennas, as used on ships, airplanes, and military land vehicles, are used in order to prevent loss of satellite signals.

Some antennas operate in the L-band range. An L-band is an electromagnetic frequency band operating in the microwave spectrum within the range of frequencies from 390 megahertz to 1550 megahertz. Currently, L-band antenna systems have the broadest coverage almost any place in the world. This is why most ships use L-band systems. The drawback to these antennas is that they have the slowest speed (and lowest bandwidth) of communication systems. In addition, they are quite expensive. Ku-band or C-band systems, however, have very fast communication speed, but only partial coverage. The speed differential is analogous to the difference between a dial-up modem and broadband internet access service. Currently, Ku-band systems are popular but their coverage is a limiting factor.

Thus, in order to be assured of full coverage in any place in the world, L-band systems are required and to have a high speed of communication, Ku-band or C-band are required (but with a limited coverage). Ships, vehicles, and airplanes that need to have a good communication link need to have both Ku-band (and C-band antennas) and an L-band antenna. C-band antennas are too big to be mounted on airplanes. In some cases, ships, vehicles, or airplanes do not have enough space to put multiple stabilizing systems.

Also, there are many cases where a user has to use multiple stabilized antennas in order to support multiple frequency-bands beyond just satellite applications. In these cases stabilizing platforms are used for mounting the antennas. Currently, there are expensive stabilizing platforms that are capable of supporting some of the multiple frequency bands of satellites such as C-band, Ku-band, Ka-band, and others. However, they use very complicated and expensive antenna systems that have one set of specially designed reflectors and feed capable of supporting multiple frequency-bands. Because of its cost, such a system is not available in the commercial market, and generally reserved for the military.

### SUMMARY OF THE INVENTION

Briefly, according to an embodiment of the invention a method for operating an antenna system includes steps or acts of: aiming the antenna system at a first source of signals in a first band when the signals in the first band are available; and aiming the antenna system at a second source of signals in a second band when the signals in the first band are not available.

According to another embodiment of the present invention, an antenna system includes: a single steering platform automatically pointing the antenna system at a specified target; a first antenna coupled with the single steering platform and operable in a first band; a second antenna operable in a second band, wherein said second antenna is coupled with the first antenna; and a controller switching between the first band and the second band such that the first antenna operates when the first band is available and the second antenna operates when the first band is not available.

According to another embodiment of the present invention, an antenna system includes: a single steering platform automatically pointing the antenna system at a specified target; a Ku band antenna attached to the single steering platform for receiving and transmitting signals in the Ku band; an L band antenna connected to the Ku-band antenna; and a controller that switches between the Ku-band and the L-band, such that the Ku-band antenna operates when the Ku-band is available and the L-band operates only when the Ku-band antenna is not available.

### BRIEF DESCRIPTION OF THE DRAWINGS

To describe the foregoing and other exemplary purposes, aspects, and advantages, we use the following detailed description of an exemplary embodiment of the invention with reference to the drawings, in which:

FIG. 1 is a schematic of an antenna system according to an embodiment of the invention;

FIG. 2 is a flowchart of a method according to an embodiment of the invention;

FIG. 3 is a simplified depiction of the two antennas in the antenna system of FIG. 1 wherein the Ku band reflector is shown at zero degrees of elevation and the L band antenna is shown at ninety degrees of elevation;

FIG. 4 is a simplified depiction of the two antennas in the antenna system of FIG. 1 wherein the Ku band reflector is shown at forty-five degrees of elevation and the L band antenna is set to a 45 degree offset of elevation; and

FIG. 5 is a simplified depiction of the two antennas in the antenna system of FIG. 1 wherein the Ku band reflector is shown at ninety degrees of elevation while the L band antenna is set to a zero degree offset of elevation.

While the invention as claimed can be modified into alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the scope of the present invention.

### DETAILED DESCRIPTION

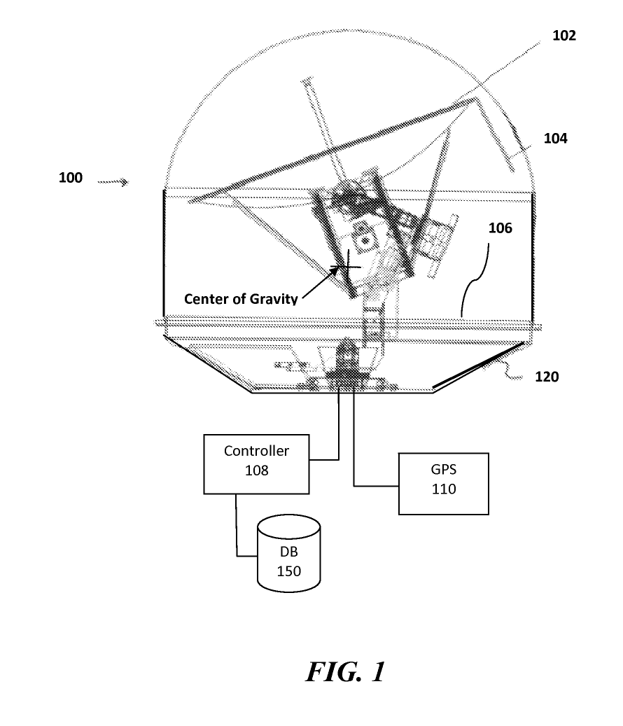

We describe a multiple antenna system operable in the L band and Ku band, with multiple band antennas supported on one shared stabilizer platform and controller by a single stabilizer. Referring to FIG. 1, according to an embodiment of the invention, an antenna system 100 includes an antenna 102 operable in a first band, depicted here as the Ku band. The system 100 as shown is configured to operate mostly in the Ku band when it is available. When the Ku band (the default band) is not available, the system 100 switches to a second antenna 104 which operates in a second band such as the L band. Both antennas 102 and 104 are physically coupled with the antenna system 100 and share a stabilizer 106 which houses a motor for pointing the antenna system 100 at locations where the first band 102 is available. In the case of an L and Ku band combination, L-band is too expensive to be a default. But even including L/KU, a default should be user-selectable because in every case, user preference will be different.

The antenna system 100 also includes a controller 108 that controls the operation of the antenna system 100 with the first or second antennas. The controller 108 is operatively coupled with the stabilizer 106 and may reside on the platform 120. The areas where Ku band signals are available are known. Therefore, the antenna system 100 can support a database 150 that includes those geographic locations where the second band is available. The database 150 is preferably operatively coupled with the controller 108.

The method to be disclosed is a way of a stabilizing an antenna platform 120 (typically supporting a single frequency band) to support multiple frequency bands in a cost-effective way. As an example of the method, the stabilized system 100 points to a Ku band satellite with the Ku band antenna system 102 (which includes the Ku band reflector and feed) activated. If there is no Ku band coverage, then the stabilized system 100 deactivates the first antenna 102 and activates the second antenna 104, which points to an L band satellite with the L-band antenna system 104 (a separate L-band reflector and feed). In this embodiment, the first antenna 102 is deactivated by moving it out of the range of the first band; and the second antenna 104 is activated by moving it into the range of the second band in order to target the second band.

The method uses a stabilizer 106 (or positioner) to point to multiple targets (satellites) with multiple antennas mounted on it. Typically, each of the antennas points to each of a number of multiple-frequency-band satellites. In principle, 1) the single stabilizing platform 120 is mounted with multiple antenna systems; 2) when a user or a program selects one from the mounted multiple antenna systems 102 and 104, the stabilizer 106 (searches and tracks) itself to point to the target satellite or object using the selected antenna system; and 3) the switching mechanism also switches the signal from the currently selected antenna band system to the desired signal path. The single stabilizing platform 120 using the disclosed method can be used to support multiple frequency-band satellites or targets.

According to an embodiment of the invention, in order to optimize the signal quality and bandwidth of the transmissions, we use the Ku band as the default band because of its signal quality and we use the L band only when the Ku band is not available. This means that the controller 108 automatically sets the position of the Ku band for activation unless the Ku band is unavailable. The intelligent controller 108 controls the positioning of the multiple antennas in order to switch between the Ku band and the L band.

The controller 108 contains or has access to the following information: 1) Information for Ku band coverage and L band coverage in terms of longitude and latitude; and 2) based on the antenna location possibly provided by a global positioning system (GPS) 110, the controller 108 makes an intelligent decision whether to activate the Ku or L bands. The controller 108 is operable to query a database 150 for positional information. The database 150 is shown here operatively coupled with the controller 108.

A situation may arise wherein the antenna location is within the Ku-band footprint, but the line of sight from the antenna 102 to the Ku band satellite is blocked by a ship's master structure, or the Ku band signals are otherwise not available or weak. In such a situation, the controller 108 makes the decision to switch to the L band 104 antenna and activates an actuator to change the positioning of the antennas. When the blockage by ship structure is clear, then the controller 108 switches back to Ku-band. If the Ku band is otherwise not available, the controller 108, while set in the L band position, then periodically switches back to the Ku band to determine whether Ku band service is available and, if it is available, switches to the Ku band for operation there.

Furthermore, the invention is not limited to the L and Ku bands but can support other combinations of antennas. The stabilizer platform 120 can mount any bands, with some modification required. The controller 108 can support any combination or all of L, C, X, Ku, and Ka-band antennas, which are all available bands in satellite communication. Other exemplary alternatives include a combination of 1) C-band (typical size 1.2M to 3 Meter) and Ku-band (typical size 45 cm to 1.2M), 2) C-band and L-band, 3) C-band and X-band, 4) C-band and Ka-band, 5) Ku-band and X-band, 5) Ku-band and Ka-band, 6) X-band and L-band, 7) X-band and Ka-band, 8) Ka-band and L-band.

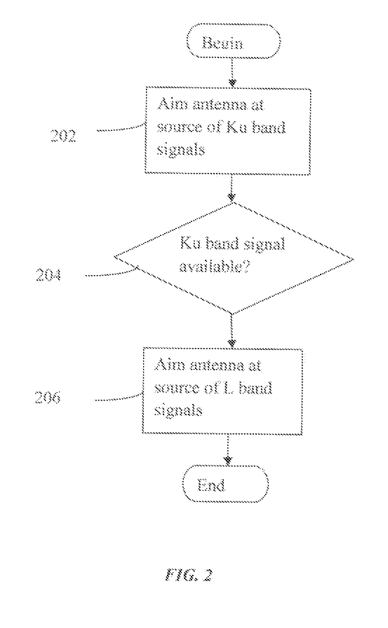

FIG. 2 is a flowchart of a method according to an embodiment of the invention. In step 202 the antenna system 100 is aimed at a source of signals in a first selected band (e.g., the Ku band) when it is known that the signals in the first band are available. Then a decision 204 is made as to whether band signals are still available in the first band in the selected position of the antenna 102. Decision 204 will periodically run to determine the availability of the first band based on user-selectable criteria.

In step 206 the antenna system 100 then deactivates the first band and activates the second band by aiming the second band antenna at a source of signals in the second band (e.g., the L band) when the source of signals in the first band is not available. Aiming the second band antenna at the source of signals will automatically cause the first band antenna to move out of position, effectively de-activating it. The antenna system 100 then operates in the second band until the first band is once again available.

FIGS. 3, 4, and 5 are simplified depictions of three different positions of the two antennas 102 and 104 in the antenna system 100 of FIG. 1. In this embodiment, the L band antenna 104 is a panel antenna fixedly attached to the Ku dish reflector 102. The L band antenna 104 can fix its position on the target satellite by pointing to the Ku band reflector 102 in directional off-sets. In FIG. 3, the Ku band reflector 102 is shown in a position of zero degrees of elevation from the horizon relative to the L band antenna 104, which is shown at 90 degrees of elevation. In this example of FIG. 3, the L band antenna 104 is set to a 90 degree offset of elevation.

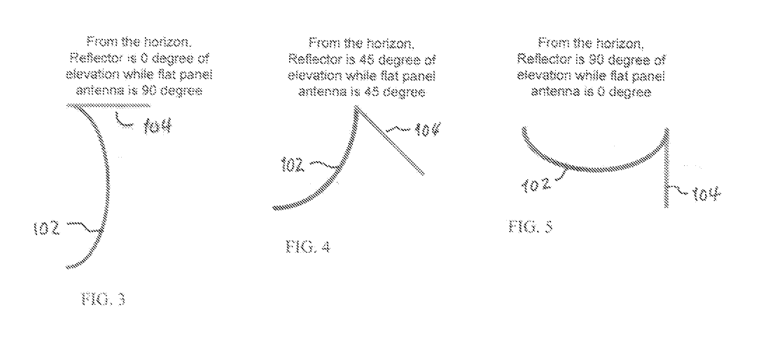

FIG. 4 depicts the Ku band reflector 102 at 45 degrees of elevation while the L band flat panel antenna 104 is set to a 45 degree offset of elevation. FIG. 5 depicts the Ku band reflector 102 at 90 degrees of elevation while the flat panel L band antenna 104 is set to a zero degree offset of elevation.

Therefore, while there has been described what is presently considered to be the preferred embodiment, it will understood by those skilled in the art that other modifications can be made within the spirit of the invention. The above description of embodiments is not intended to be exhaustive or limiting in scope. The embodiments, as described, were chosen in order to explain the principles of the invention, show its practical application, and enable those with ordinary skill in the art to understand how to make and use the invention. It should be understood that the invention is not limited to the embodiments described above.

1. An antenna system comprising:
a single steering platform automatically pointing the antenna system at a specified target;
a first antenna operable in a first band, wherein said first antenna is coupled to the single steering platform;
a second antenna operable in a second band, wherein said second antenna is coupled with the first antenna; and
a controller operably coupled with the single steering platform, said controller switching between the first band and the second band by activating the first antenna when the first band is available and activating the second antenna when the first band is not available.

2. The antenna system of claim 1, further comprising a database comprising geographic locations where the second band is available.

3. The antenna system of claim 2 wherein the database is operatively coupled with the controller.

4. The antenna system of claim 1, wherein the first band is a Ku band.

5. The antenna system of claim 4, wherein the second band is an L band.

6. The antenna system of claim 1 further comprising a global positioning system operable to determine a location of the antenna system.

7. The antenna system of claim 1 further comprising a database of geographic locations where the first band is available, wherein the controller queries said database for positional information.

8. The antenna system of claim 7 wherein the database further comprises geographic locations where the second band is available.

9. The antenna system of claim 1 wherein the single steering platform comprises a motor for actuating the antenna system to point at the specified target.

10. The antenna system of claim 1 wherein activating the first antenna comprises:
moving the first antenna into range of the first band.

11. The antenna system of claim 10 wherein activating the second antenna comprises:
moving the second antenna into range of the second band; and
simultaneously moving the first antenna out of range of the first band.

12. An antenna system comprising:
a single steering platform automatically pointing the antenna system at a specified target;
a Ku band antenna attached to the single steering platform for receiving and transmitting signals in the Ku band;
an L band antenna connected to the Ku-band antenna; and
a controller that switches between Ku-band and L-band, such that the Ku-band antenna operates when the Ku-band is available and the L-band antenna operates only when the Ku-band antenna is not available.

13. A method for operating an antenna system, said method comprising steps of:
aiming the antenna system at a first source of signals in a first band when signals in the first band are available;
aiming the antenna system at a second source of signals in a second band when the signals in the first band are not available;
wherein the antenna system comprises a first antenna operable in the first band; and a second antenna operable in the second band.

14. The method of claim 13 further comprising a step of determining a location of the antenna system.

15. The method of claim 13, wherein the first band is a Ku band.

16. The method of claim 15, wherein the second band is an L band.

17. The method of claim 13
wherein aiming the antenna system at the first source of signals comprises deactivating the second antenna and moving the first antenna into range of the first band; and
wherein aiming the antenna system at the second source of signals comprises deactivating the first antenna and moving the second antenna into range of the second band.

18. The method of claim 15 further comprising setting the first band as a default band for aiming.

19. The method of claim 14 further comprising querying a database for positional information.

20. The method of claim 13 further comprising querying a global positioning system for positional information.
